(19) United States
(12) Patent Application Publication
(10) Pub. No.: US 2015/0224548 A1
(43) Pub. Date: Aug. 13, 2015

(54) MANUFACTURING METHOD AND MANUFACTURING APPARATUS OF LIQUID CRYSTAL DISPLAY DEVICE

(71) Applicant: Japan Display Inc., Minato-ku (JP)

(72) Inventor: Yojiro SHIMADA, Tokyo (JP)

(73) Assignee: Japan Display Inc., Minato-ku (JP)

(21) Appl. No.: 14/613,514

(22) Filed: Feb. 4, 2015

(30) Foreign Application Priority Data
Feb. 7, 2014 (JP) 2014-022201

(51) Int. Cl. B08B 3/02

(52) U.S. Cl. CPC B08B 3/024

(57) ABSTRACT

In a method for manufacturing a liquid crystal display device provided with a display panel having a liquid crystal layer sandwiched between substrates, the substrate is washed with a washing liquid shower of a flow rate distribution having a single peak.

### CLAIM OF PRIORITY

The present application claims priority from Japanese patent application JP 2014-22201 filed on Feb. 7, 2014, the content of which is hereby incorporated by reference into this application.

### BACKGROUND OF THE INVENTION

1. Field of the Invention

The present invention relates to a manufacturing method and a manufacturing apparatus of a liquid crystal display device.

2. Description of the Related Art

A liquid crystal display device has its applications expanded due to such features as high display quality, thin type, light weight, low-power consumption, etc., and therefore has been used for various applications ranging from portable monitors such as monitors for portable cellular phones and monitors for digital still cameras to monitors for desk top personal computers, monitors for printing or design, monitors for medial field, and liquid crystal televisions. With the above expanded applications, higher image quality and higher quality are required of the liquid crystal display. In particular, strongly required is higher brightness and lower power consumption which are attributable to higher transmission factor. In addition, with the liquid crystal display devices becoming more populated, there is a strong need for reduced cost as well.

Ordinarily, display of the liquid crystal display device takes such operations as, alignment direction of liquid crystal molecules is changed by applying an electric field to the liquid crystal molecules of the liquid crystal layer sandwiched by a pair of substrates, and then optical characteristic of the liquid crystal layer changes. As a result, these operations work for the display. The alignment direction of the liquid crystal molecule at the time of no applying of the electrical field is defined by an alignmebnt film having been subjected to rubbing of the surface of a polyimide thin film. However, due to problems such as static electricity and foreign mater which are caused by the rubbing, rubbing uniformity caused by irregularities of the surface of the substrate, or any other problem, a photo alignment method without the need of contact with a rubbing cloth is about to be adopted. The photo alignment method includes giving an alignment performance to the surface of an organic coated film by irradiating a substantially linearly polarized UV light to the surface of the organic membrane formed on the surface of the substrate, or any other operation. When being irradiated by the UV light, the photo alignment film causes an impurity decomposed matter. Thus, this impurity decomposed matter is removed by heat treatment. In addition, a washing apparatus for wet washing, etc. after a lithographic process is disclosed, for example, in Japanese Patent Application Laid-Open No. 2004-273743.

### SUMMARY OF THE INVENTION

The present inventors have studied about applying, a photo alignment film having a past result in the liquid crystal displace device for large TVs, to small or middle liquid crystal displace devices for mobiles, etc. However, implementing a heat treatment for removing the decomposed matter caused by irradiating the UV to the photo alignment film has found out that the color filter becomes deteriorated. However, it has been determined that moving of impurity is of difficulty at a low heat treatment temperature.

Then, the present inventors have tried to remove the impurity with the wet washing. FIG. 1A shows a side view of a schematic structure of a washing apparatus 200 used, and FIG. 1B shows a top view of the same. The washing apparatus 200 is provided with an aqua knife portion 210, a washing liquid showering portion 220 and a pure water showering portion 230. In the aqua knife portion 210, an aqua knife (pure water in a form of a curtain) 211 formed longer than a substrate's width dimension in the direction intersecting with a conveying direction 151 is supplied to the substrate 150. By this operation, a pure water membrane in a form of a substantially even thin layer is formed on the entire upper face of the substrate 150, thus making it possible to suppress occurrence of washing unevenness or stain which may be caused in the washing treatment.

The washing liquid showering portion 220 is, relative to the aqua knife portion 210, arranged on the downstream side in the conveying direction 151 of the substrate 150. In the washing liquid showering portion 220, washing liquid nozzle portions 221 fitted with a plurality (four herein) of nozzles 223 are arranged, with a plurality of steps (four steps herein), parallel to the direction intersecting with the conveying direction 151. The washing liquid 222 injected from the nozzle 223 spreads as a mist in a form of a cone (full cone type nozzle). In addition, the spread of the washing liquid 222, the interval between the respective adjacent nozzles 223, and the interval between the respective adjacent washing liquid nozzle portions 221 are so set that the washing liquids 222 from the adjacent nozzles 223 partly overlap on the substrate 150.

The pure water showering portion 230 is placed for washing away the washing liquid adhering to the substrate at the washing liquid showering portion 220, and is disposed, relative to the washing liquid showering portion 220, on the downstream side in the conveying direction 151 of the substrate 150. In the pure water showering portion 230, pure water nozzle portions 231 fitted with a plurality (four herein) of nozzles 233 are arranged, with a plurality of steps (4 steps herein), parallel to the direction intersecting with the conveying direction 151. The pure water 232 injected from the nozzle 233 spreads as a mist in a form of a cone (full cone type nozzle). In addition, the spread of the pure water 232, the interval between the respective adjacent nozzles 233, and the interval between the respective adjacent pure water nozzle portions 231 are so set that the washing liquids from the adjacent nozzles 233 partly overlap on the substrate 150.

As a result of removing, by using the above washing apparatus, the impurity caused by the UV irradiating, only about 50% was removed, failing to bring about a sufficient washing effect. In addition, insufficient removal of the impurity causes an alignment failure, thus lowering reliability of the liquid crystal display device.

It is an object of the present invention to provide a method of washing a liquid crystal display device capable of improving yield which method is capable of obtaining a sufficient effect of washing even an impurity caused by UV irradiating, and to provide a washing apparatus having a high washing capability.

As a first embodiment for accomplishing the above object, there is provided a method for manufacturing a liquid crystal display device provided with a display panel having a liquid crystal layer sandwiched between substrates, the method including:

a first process for preparing a first substrate; and

a second process for washing the first substrate with a washing liquid shower of a flow rate distribution having a single peak.

Moreover, there is provided an apparatus for manufacturing a liquid crystal display device and for washing a substrate included in a liquid crystal display panel, the apparatus including:

an aqua knife portion; a washing liquid showering portion; a pure water showering portion; and a conveying mechanism portion for conveying a washed object from the aqua knife portion to the washing liquid showering portion and further to the pure water showering portion,

wherein a flow rate distribution of a washing liquid injected from the washing liquid showering portion has a single peak.

### BRIEF DESCRIPTION OF THE DRAWINGS

FIG. 1A is a schematic side view of a washing apparatus for explaining about a washing treatment, which apparatus was studied by the inventors;

FIG. 1B shows a schematic top view of the washing apparatus for explaining about the washing treatment, which apparatus was studied by the inventors;

FIG. 2 show diagrams for explaining about the state of a medicinal solution in the washing treatment, which solution was studied by the inventors, where FIG. 2A is a perspective view showing an expansion of the washing liquid injected from a nozzle, FIG. 2B is a top view showing the expansion of the washing liquid injected from the nozzle, and FIG. 2C is a flow rate distribution diagram of the washing liquid injected from the nozzle;

FIG. 3A is a schematic side view of a washing apparatus, according to a first embodiment of the present invention;

FIG. 3B is a schematic top view of the washing apparatus, according to the first embodiment of the present invention;

FIG. 4 are diagrams for explaining about a state of the medicinal solution in the washing treatment, according to the first embodiment of the present invention, where FIG. 4A is a perspective view showing an expansion of the medicinal solution injected from a nozzle, FIG. 4B is a top view showing an expansion of the medicinal solution injected from the nozzle, and FIG. 4C is a flow rate distribution diagram of the medicinal solution injected from the nozzle;

FIG. 5A is a flow chart of an alignment film forming process in the method of manufacturing the liquid crystal display device, according to the first embodiment of the present invention;

FIG. 5B is a flow chart of a photo alignment process in the method of manufacturing the liquid crystal display device, according to the first embodiment of the present invention;

FIG. 6A is a schematic cross sectional view, of a TFT substrate or an opposing substrate, for explaining about the alignment film forming process in the method of manufacturing the liquid crystal display device, according to the first embodiment of the present invention;

FIG. 6B is a schematic plan view, of the TFT substrate or the opposing substrate, for explaining about the alignment film forming process in the method of manufacturing the liquid crystal display device, according to the first embodiment of the present invention; and

FIG. 7 is a schematic plan view of the liquid crystal display device.

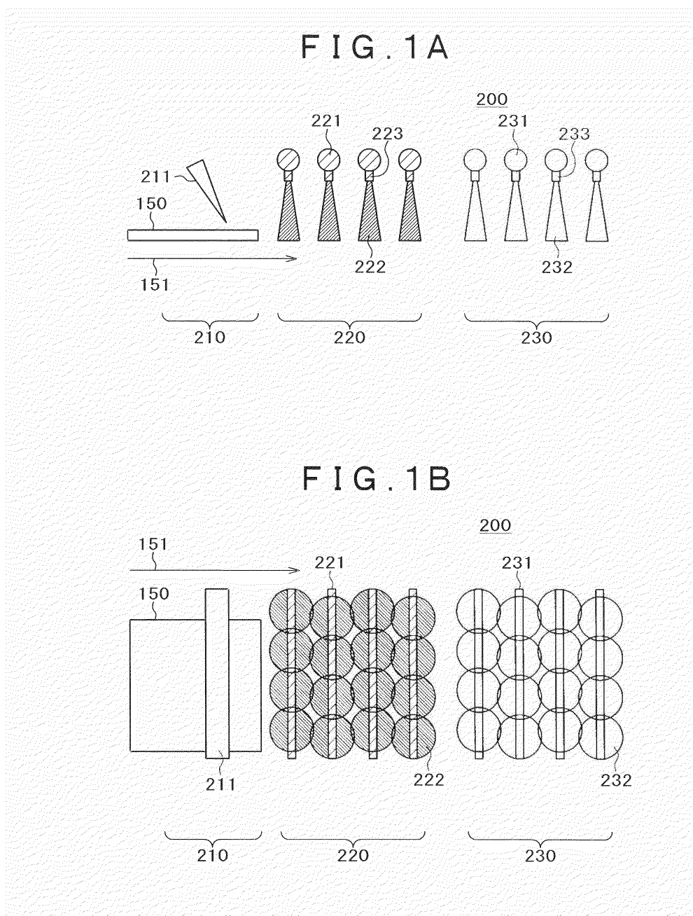

### DESCRIPTION OF THE PREFERRED EMBODIMENTS

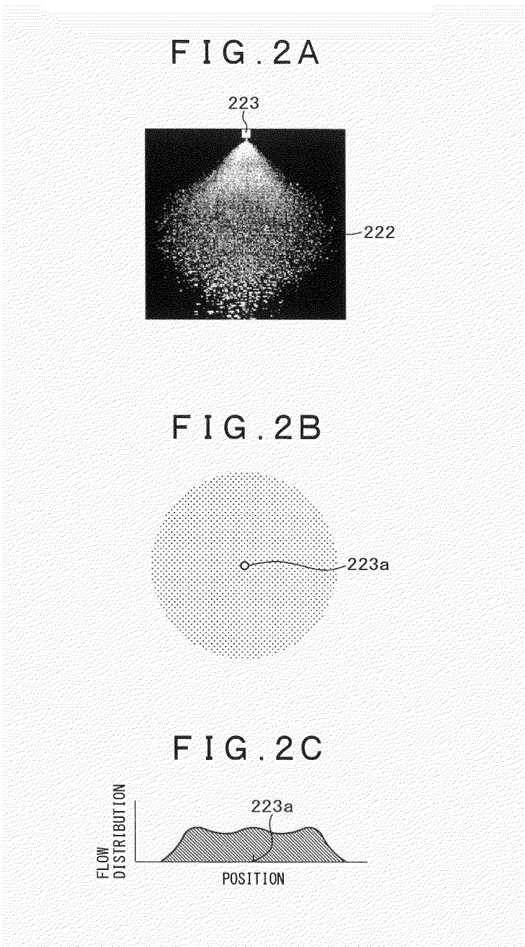

The inventors have studied especially about a washing liquid showering portion 220 as a main component of a washing treatment so as to investigate causes for failing to obtain a sufficient effect of removing impurities with a washing apparatus used. FIG. 2 show diagrams for explaining about the state of a washing liquid 222 in the washing treatment, which washing liquid 222 was studied by the inventors, where FIG. 2A is a perspective view showing an expansion of the washing liquid injected from a nozzle 223, FIG. 2B is a top view showing the expansion of the washing liquid 222 injected from the nozzle 223, and FIG. 2C is a flow rate distribution diagram of the washing liquid 222 injected from the nozzle 223. Reference numeral 223a denotes a position of the nozzle (223). As a result, especially, from the flow rate distribution of the washing liquid in FIG. 2C, it has been estimated that, in the case of a full-cone type nozzle used by the inventors, hitting force to a substrate of the washing liquid is weak. That is, it has been estimated that, due to an even flow rate distribution, the hitting force to the surface of the substrate is made even, and that speed of the washing liquid flowing away on the substrate is made even within the surface.

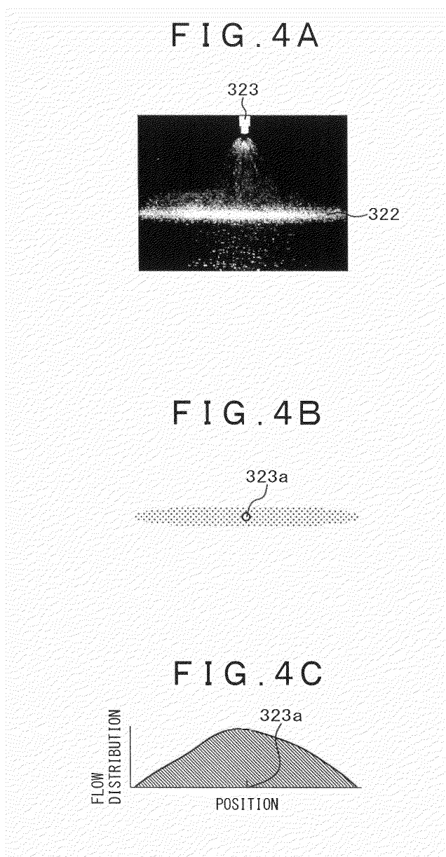

Then, the inventors have studied about a method for enhancing the hitting force of the washing liquid to the surface of the substrate and for enhancing the speed of the washing liquid flowing away from on the substrate, thus leading to replacing the full-cone type nozzle with a fan-shaped flat type nozzle. FIG. 4 show a state of a washing liquid in the case of using the fan-shaped flat type nozzle. FIG. 4A is a perspective view showing an expansion of a washing liquid injected from a nozzle 323, FIG. 4B is a top view showing the expansion of the washing liquid 322 injected from the nozzle 323, and FIG. 4C is a flow rate distribution diagram of the washing liquid 322 injected from the nozzle 323. Reference numeral 323a denotes a position of the nozzle (323). Use of the fan-shaped flat type nozzle allows injecting of the clearing liquid, in a form of a fan, from a tip end of the nozzle, thus spreading the washing liquid in a form of an ellipse in FIG. 4B showing the top view. The flow rate distribution of the washing liquid becomes a form of a mountain having a single peak, thus making stronger or weaker the hitting force to the surface of the substrate. This operation activates turbulence of the washing liquid, thus making it possible to enhance the speed of the washing liquid which flows, on the substrate, from a region of strong hitting force to a region of weak hitting force. This can up the effect of removing impurities by the washing liquid. In addition, with respect to removing of impurities, flow rate distribution of the washing liquid is more important than enlarging the absolute value of the hitting force. Even increasing, with the full-cone type, the flow rate of the washing liquid of the washing liquid brings about a small effect of improving the property of removing impurities.

Hereinafter, referring to drawings, explanations will be made about each embodiment of the present invention.

In addition, the disclosure is merely an example. Thus, any change which may be, with the gist of the prevention being kept, imagined with ease by a person skilled in the art will be, as a matter of course, included in the scope of the present invention. In addition, for more clarifying the explanation, the drawings are, as the case may be, expressed in terms of width, thickness, configuration, etc. of each portion more schematically than the actual embodiment. However, the drawings are merely an example and therefore do not limit interpretation of the present invention.

In addition, in this specification as well as each of the drawings, any element similar to those mentioned earlier with respect to the already-mentioned drawings will be, as the case may be, added by the same reference numeral or sign and detailed explanation will be properly omitted.

### First Embodiment

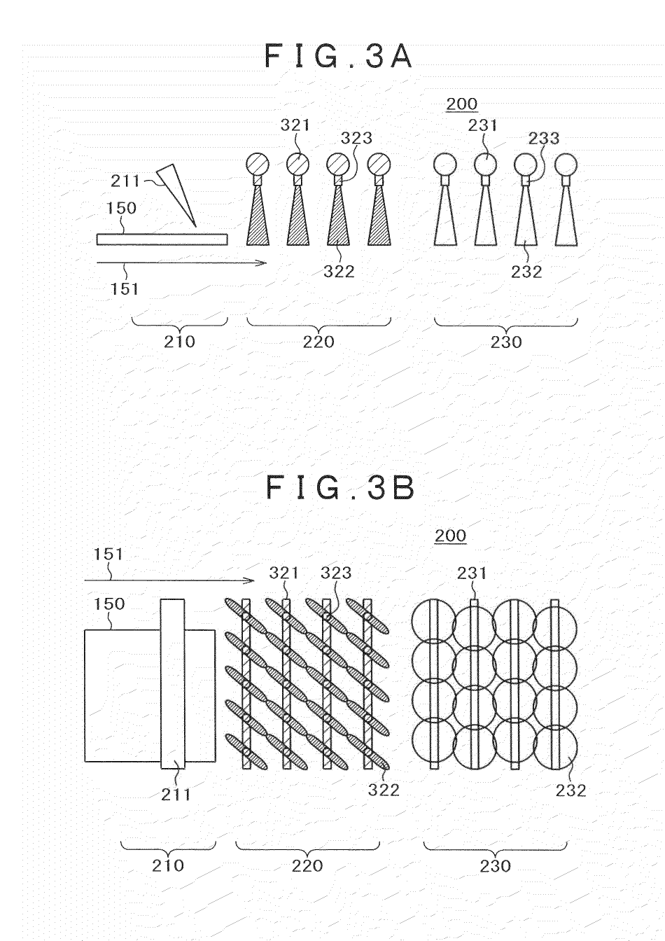

Referring to FIG. 3A, FIG. 3B and FIG. 4, an explanation will be made about a manufacturing apparatus (washing apparatus) of a liquid crystal display device, according to a first embodiment of the present invention. FIG. 3A shows a schematic side view of a washing apparatus used, for a washing treatment after a photo alignment, in a method of manufacturing a liquid crystal display device according to this embodiment, and FIG. 3B is a top view of the washing apparatus.

As shown in FIG. 3A and FIG. 3B, the washing apparatus 200 is provided with an aqua knife portion 210, a washing liquid showering portion 220, a pure water showering portion 230, and a conveying mechanism portion which sequentially conveys a washed object to each portion (210, 220, or 230). In the aqua knife portion 210, an aqua knife (pure water in a form of curtain) 211 formed longer than a substrate 150's width dimension in the direction intersecting with a conveying direction 151 of the substrate 150 is supplied to the substrate 150. By this operation, a pure water membrane in a form of a substantially even thin layer is formed on the entire upper face of the substrate 150, thus making it possible to suppress occurrence of washing unevenness or stain which may be caused in the washing treatment at the washing liquid showering portion 220. Forming of a liquid membrane on the substrate can suppress the washing unevenness, etc. in the washing treatment. Thus, any liquid with a low reactivity can be used as an aqua knife. In view of contamination, etc. from the liquid, however, pure water is desired.

The washing liquid showering portion 220 is, relative to the aqua knife portion 210, arranged on the downstream side of the substrate 150 in the conveying direction 151 of the substrate 150. In the washing liquid showering portion 220, washing liquid nozzle portions 321 respectively fitted with a plurality (four herein) of fan-shaped flat type nozzles 323 are arranged, with a plurality of steps (4 steps herein), parallel to the direction intersecting with the conveying direction 151. The washing liquid 322 injected from the nozzle 323 spreads as a mist in a form of a fan. In addition, the spread of the washing liquid 322 and the interval between the respective adjacent washing liquid nozzle portions 321 are so set that the washing liquids 322 from the adjacent nozzles 323 partly overlap on the substrate for allowing the washing liquid to go throughout the substrate. In addition, when the distance between the aqua knife and the washing liquid shower is too long, the pure water membrane formed by the aqua knife may be evaporated, thereby exposing part of whole of the substrate, thus causing a washing variation within the substrate face, especially, on the upstream side and downstream side in the conveying direction. Due to this, it is preferable that the distance between the aqua knife and the washing liquid shower be defined within the distance area where the substrate is exposed by the evaporation of the pure water membrane.

The pure water showering portion 230 is placed for washing away the washing liquid adhering to the substrate at the washing liquid showering portion 220, and is disposed, relative to the washing liquid showering portion 220, on the downstream side in the conveying direction 151 of the substrate 150. In the pure water showering portion 230, pure water nozzle portions 231 respectively fitted with a plurality (four herein) of full-cone type nozzles 233 are arranged, with a plurality of steps (4 steps herein), parallel to the direction intersecting with the conveying direction 151. The pure water 232 injected from the nozzle 233 spreads as a mist in a form of a cone. In addition, the spread of the pure water 232 and the interval between the respective adjacent pure water nozzle portions 231 are so set that the washing liquids from the adjacent nozzles 233 partly overlap on the substrate 150 for preventing remnant of the washing liquid adhering to the substrate.

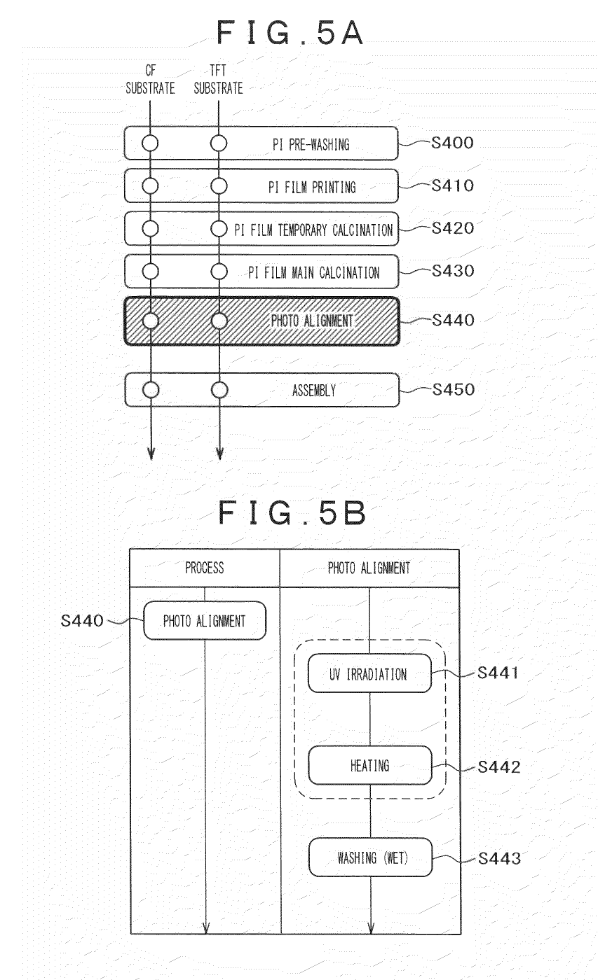

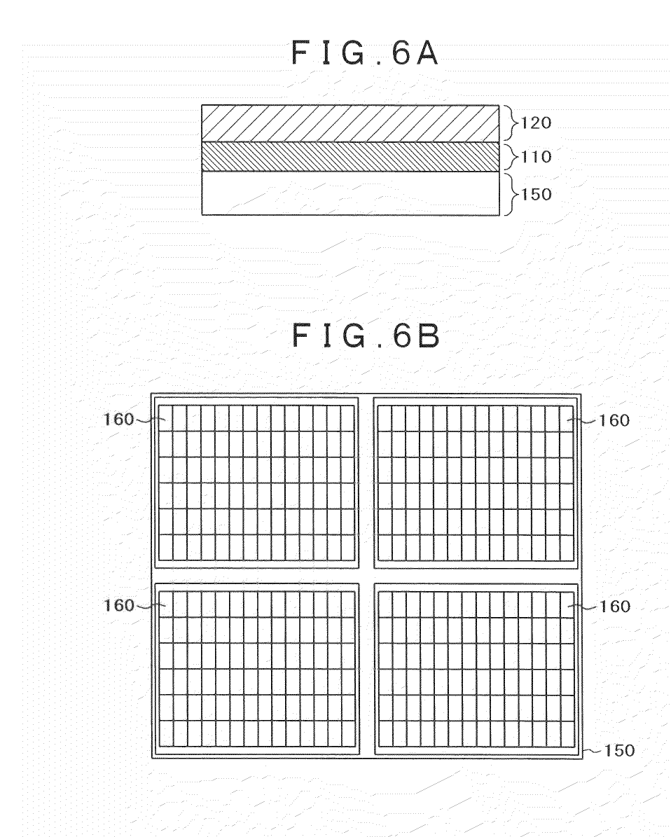

Then, referring to FIG. 5A, FIG. 5B, FIG. 6A and FIG. 6B, an explanation will be made about the method of manufacturing the liquid crystal display device, especially the process for forming the alignment film. FIG. 5A shows a flow chart of the alignment film forming process in the method of manufacturing the liquid crystal display device, according to this embodiment. In addition, in the case of using a TFT substrate formed with a thin film transistor, etc., as well, only the layer structure of an opposing substrate opposing the TFT substrate differs, and therefore the alignment film forming process is basically the same. Thus, an explanation is made based on the example of the opposing substrate (CF process). In this case, however, depending on the layer structure of the TFT substrate and opposing substrate, removing of impurity can be accomplished by heat treatment, instead of wet washing.

At first, the substrate 150 formed with a color filter is prepared. Then, a preliminary PI (polyimide) washing before forming of the alignment film on the substrate is made by using a medicinal solution such as neutral detergent, etc (step S400). Then, the alignment film (PI film) is formed by a flexo printing, an ink jet application, etc. (step S410). Then, the PI film is subjected to a temporary firing at a temperature about 40° C. (step S420). Continuously, the PI film is subjected to a main firing with a bake furnace heated at about 150° C. (step S430). Then, PI film is subjected to a photo alignment treatment (step S440). The photo alignment treatment (step S440), as shown in FIG. 5B, includes a PI photo-decomposing with a UV irradiating (step S441), bridging-rearranging of the portion decomposed by heating (step S422), and removing of the foreign matter, impurities, etc., by washing (wet) (step S443). Step S443 was implemented by using the washing apparatus (shown in FIG. 3A and FIG. 3B) where the washing liquid showering portion 220 is provided with the fan-shaped flat type nozzle. In addition, as a washing liquid, an inorganic washing agent such as alkali water, hydrogen water and neutral detergent, etc., or organic solvent such as acetone, tetramethylammonium hydroxide, isopropyl alcohol, etc. can be used.

FIG. 6A shows an example of a cross sectional view of the substrate formed with the photo alignment film. In FIG. 6A, in the case of the opposing substrate, the reference numeral 110 denotes a multilayer structure film including constitutional elements such as color filter, black matrix, overcoat film, etc. In the case of a TFT substrate formed with a thin film transistor (TFT), the reference numeral 110 denotes a multilayer structure film including constitutional elements such gate insulating film, gate electrode, semiconductor layer, source electrode, drain electrode, inorganic protective film, organic protective film, pixel electrode, etc. The photo alignment film 120 is formed on the multilayer structure film 110. In addition, FIG. 6B shows an example of a plan view of the substrate. The substrate 150 has a plurality of display panel areas 160.

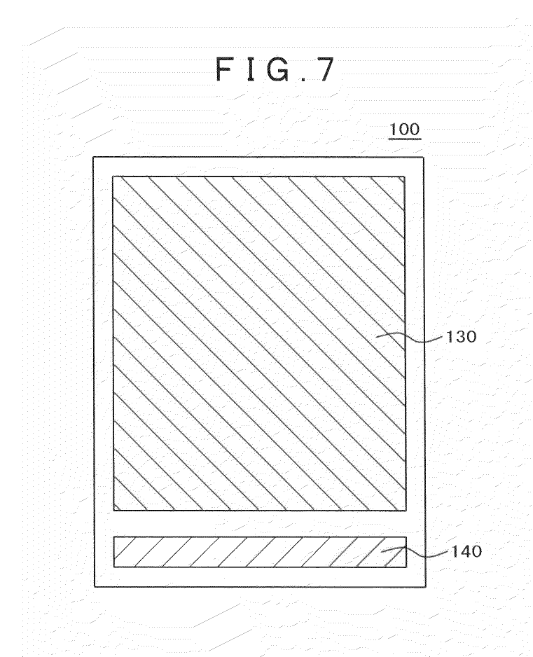

The TFT substrate and the opposing substrate each formed with the photo alignment film are so attached as to have the photo alignment films oppose each other, thus sandwiching the liquid crystal layer between the substrates, following by dividing into individual display panels. Then, combining a back light, etc. with the individual panels (step S450 in FIG. 5A) completes a plurality of liquid crystal display devices 100 shown in FIG. 7. The reference numeral 130 denotes a display area, and the reference numeral 140 denotes a driving circuit portion.

The liquid crystal display device was manufactured by using, in the washing liquid showering portion, the fan-shaped flat type nozzle, instead of the full-cone type nozzle. This has accomplished substantially 100% removal of the impurities in the photo alignment film which impurities were caused by irradiating of UV, thus making it possible to provide the liquid crystal displace device featuring a high quality. In addition, improving of yield (improvement of productivity) and reducing of the medicinal solution and energy have been accomplished, thus making it possible to reduce the manufacturing cost.

In addition, according to this embodiment, the explanation has been made based on washing of the photo alignment film for removing the impurity caused by the UV irradiating. However, not limited to the washing of the photo alignment film, this embodiment is also applicable to washing of an organic film for removal of metamorphosis layer or to washing for removing foreign matters after patterning of wiring.

As set forth above, according to this embodiment, it is possible to provide a method of washing a liquid crystal display device capable of improving yield which method is capable of obtaining a sufficient effect of washing even an impurity caused by UV irradiating, and to provide a washing apparatus having a high washing capability.

Within the category of the concept of the present invention, a person skilled in the art can imagine various examples for changes or modifications, and such examples for changes or modifications are also interpreted to belong to the scope of the present invention. For example, any proper additions to, proper deletions from and proper design changes to each of the above embodiments, or any additions to, omissions from and conditional changes to each of the above embodiments are also included in the scope of the present invention as long as the aforementioned are provided with the gist of the present invention.

In addition, it should be interpreted that, with respect to any other operation or effect brought about from the mode set forth according to the embodiment, those obvious from this description, or those properly imagined by a person skilled in the art are, as a matter of course, brought about by the present invention.

What is claimed is:

1. A manufacturing apparatus of a liquid crystal display device for washing a substrate included in a liquid crystal display panel, the apparatus comprising:
an aqua knife portion;
a washing liquid showering portion;
a pure water showering portion; and
a conveying mechanism portion for conveying an object to be washed from the aqua knife portion to the washing liquid showering portion and further to the pure water showering portion,
wherein a flow rate distribution of a washing liquid injected from the washing liquid showering portion has a single peak.

2. The manufacturing apparatus according to claim 1,
wherein a position of the single peak is a middle portion of the flow rate distribution.

3. The manufacturing apparatus according to claim 1,
wherein a nozzle disposed at the washing liquid showering portion is of a fan-shaped flat type.

4. The manufacturing apparatus according to claim 3,
wherein the nozzle is arranged at the washing liquid showering portion, and a plurality of the nozzles are arranged at washing liquid nozzle portions extending along a direction intersecting with a direction for conveying, by the conveying mechanism portion, the object to be washed.

5. The manufacturing apparatus according to claim 4,
wherein the washing liquid nozzle portions are arranged, with a plurality of steps, along and parallel to the direction intersecting with the conveying direction of the object to be washed.

6. The manufacturing apparatus according to claim 1,
wherein a washing target at the washing liquid showering portion is an impurity, caused by an ultra violet ray, in a photo alignment film.

7. The manufacturing apparatus according to claim 6,
wherein the aqua knife portion forms a liquid membrane on a surface of the object to be washed.

8. The manufacturing apparatus according to claim 7,
wherein the liquid membrane is a pure water membrane.

9. The manufacturing apparatus according to claim 1,
wherein a nozzle disposed at the pure water showering portion is of a full-cone type.

10. A manufacturing method of a liquid crystal display device provided with a display panel having a liquid crystal layer sandwiched between substrates, the method comprising:
a first process for preparing a first substrate; and
a second process for washing the first substrate with a washing liquid shower of a flow rate distribution having a single peak.

11. The manufacturing method of the liquid crystal display device according to claim 10,
wherein the single peak is positioned in a middle portion of the flow rate distribution.

12. The manufacturing method of the liquid crystal display device according to claim 10,
wherein the washing liquid shower is injected with a fan-shaped flat type nozzle.

13. The manufacturing method of the liquid crystal display device according to claim 10,
wherein a photo alignment film is formed on a surface of the first substrate prepared in the first process and a washing target is an impurity in the photo alignment film.

14. The manufacturing method of the liquid crystal display device according to claim 10,
wherein the second process includes a process for forming a liquid membrane before washing the first substrate with the washing liquid shower.

15. The manufacturing method of the liquid crystal display device according to claim 14,
wherein the liquid membrane is a pure water membrane and is formed by an aqua knife.

16. The manufacturing method of the liquid crystal display device according to claim 13,
wherein the liquid crystal layer is sandwiched between the first substrate having the washed photo alignment film and a second substrate formed with an alignment film.

17. The manufacturing method of the liquid crystal display device according to claim 10,
wherein the first substrate includes a color filter, the second substrate includes a thin film transistor, and the alignment film formed on the second substrate is a photo alignment film.
